(19) United States
(12) Patent Application Publication
(10) Pub. No.: US 2018/0080839 A1
(43) Pub. Date: Mar. 22, 2018

(54) PIEZOELECTRIC MATERIAL TEST PROBE AND METHOD

(71) Applicant: Qualcomm Incorporated, San Diego, CA (US)

(72) Inventor: Farhad Taghibakhsh, Cupertino, CA (US)

(21) Appl. No.: 15/272,207

(22) Filed: Sep. 21, 2016

(51) Int. Cl. G01L 1/16; G01L 25/00

(52) U.S. Cl. CPC G01L 1/16; G01H 11/08; G01L 25/00

(57) ABSTRACT

This disclosure provides systems, methods and apparatus for a test probe for characterizing piezoelectric material. In one aspect, a test probe may include a conductive tip configured to apply force to the piezoelectric material and provide a charge signal representing charge generated by the piezoelectric material as the piezoelectric material experiences the force. A force sensor within the test probe may generate a force signal representing the force being applied. A piezoelectric coefficient d₃₃ may be determined from the charge signal and the force signal.

### TECHNICAL FIELD

This disclosure relates to piezoelectric material characterization, and more specifically, to test probes and methods of determining piezoelectric coefficients for piezoelectric material.

### DESCRIPTION OF THE RELATED TECHNOLOGY

Ultrasonic sensor systems may use an ultrasonic transmitter to generate and send an ultrasonic wave through an ultrasonically transmissive medium or media and towards an object to be detected. The ultrasonic transmitter may be operatively coupled to an ultrasonic sensor array configured to detect portions of the ultrasonic wave that are reflected from the object. For example, in ultrasonic fingerprint sensors, an ultrasonic pulse may be produced by starting and stopping the transmitter during a short interval of time. At each material interface encountered by the ultrasonic pulse, a portion of the ultrasonic pulse may be reflected.

For example, in the context of an ultrasonic fingerprint sensor, the ultrasonic wave may travel through a platen on which an object such as a person's finger may be placed to obtain fingerprint image information. After passing through the platen, some portions of the ultrasonic wave may encounter skin that is in contact with the platen, e.g., fingerprint ridges, while other portions of the ultrasonic wave encounter air, e.g., valleys between adjacent ridges of a fingerprint, and may be reflected with different intensities back towards the ultrasonic sensor array. The reflected signals associated with the finger may be processed and converted to digital values representing the signal strengths of the reflected signals. When such reflected signals are collected over a distributed area, the digital values of such signals may be used to produce a graphical display of the signal strength over the distributed area, for example by converting the digital values to an image, thereby producing an image of the fingerprint. Thus, an ultrasonic sensor system may be used as a fingerprint sensor or other type of biometric scanner.

The ultrasonic transmitter and/or the ultrasonic sensor array of the ultrasonic sensor system may include one or more layers of piezoelectric material. A piezoelectric transmitter layer may expand and contract when a transmitter excitation voltage is applied across the piezoelectric transmitter layer to generate and transmit ultrasonic waves. A piezoelectric receiver layer may generate surface charges that vary with the magnitude and sign of the reflected ultrasonic wave and can be detected. The strength and uniformity of the transmitted ultrasonic waves and the signal strengths of the reflected signals depend in part on the uniformity of the piezoelectric coefficients associated with the piezoelectric transmitter and/or receiver layers. Nondestructive in-line methods of measuring and monitoring the piezoelectric coefficients during manufacturing of the piezoelectric layers and the ultrasonic sensors are desirable.

### SUMMARY

The systems, methods and devices of this disclosure each have several innovative aspects, no single one of which is solely responsible for the desirable attributes disclosed herein.

One innovative aspect of the subject matter described in this disclosure can be implemented in a test probe for characterizing piezoelectric material. The test probe may include a conductive tip configured to apply force to the piezoelectric material when the test probe touches an assemblage including the piezoelectric material, the conductive tip also configured to provide a charge signal representing charge generated in response to the force being applied to the piezoelectric material; and a force sensor configured to provide a force signal representing the force being applied to the piezoelectric material.

In some implementations, the force sensor may be mechanically coupled to the conductive tip. In some implementations, the test probe includes an insulator component mechanically coupling the force sensor to the conductive tip. In some implementations, the force sensor may be configured to provide the force signal as the force may be applied to the piezoelectric material. In some implementations, the test probe may include a driver component configured to receive a drive signal and vibrate the conductive tip in response to the drive signal. In some implementations, the charge signal and the force signal may be generated using a single side of the piezoelectric material. In some implementations, the test probe may include a test probe tip in which the conductive tip and the force sensor are disposed. In some implementations, the test probe may include a protective coating disposed upon the conductive tip and configured to touch the assemblage to apply the force to the piezoelectric material. In some implementations, the protective coating may include a dielectric material. In some implementations, the protective coating may include a piezoelectric material. In some implementations, the test probe may include one or more weights or springs within the test probe, the weights or springs configured to apply the force to the piezoelectric material.

Another innovative aspect of the subject matter described in this disclosure can be implemented in a system including a test probe configured to generate a charge signal corresponding to charge generated in response to the test probe applying force to a piezoelectric material, and generate a force signal corresponding to the force applied to the piezoelectric material; and a measurement system configured to determine a piezoelectric coefficient of the piezoelectric material based on the charge signal and the force signal.

In some implementations, a peak value of the charge signal and a peak value of the force signal may be used to determine the piezoelectric coefficient. In some implementations, the piezoelectric coefficient may comprise a piezoelectric coefficient of the piezoelectric material. In some implementations, the charge signal may be provided by a conductive tip of the test probe, and the force signal may be provided by a force sensor integrated within the test probe. In some implementations, the force sensor may be mechanically coupled to the conductive tip. In some implementations, the piezoelectric material may be assembled on a substrate with a single side of the piezoelectric material exposed to the test probe.

Another innovative aspect of the subject matter described in this disclosure can be implemented in a method including applying a force to a piezoelectric material by touching the piezoelectric material with a test probe; providing a charge signal corresponding to charge generated by the piezoelectric material in response to the force being applied; providing a force signal corresponding to the force applied to the piezoelectric material; and determining a piezoelectric coefficient of the piezoelectric material using the charge signal and the force signal.

In some implementations, the method may include determining the piezoelectric coefficient comprises determining a voltage value of the charge signal corresponding to one or both of a positive peak or a negative peak of the charge signal; determining a voltage value of the force signal corresponding to a positive peak or a negative peak of the force signal; and determining the piezoelectric coefficient based on the voltage value of the charge signal and the voltage value of the force signal. In some implementations, a protective layer or a metallized electrode layer may be disposed on a surface of the piezoelectric material, and wherein the force may be applied, at least in part, to the piezoelectric material through the protective layer or the metallized electrode layer.

Another innovative aspect of the subject matter described in this disclosure can be implemented in a non-transitory medium having software stored thereon, the software including instructions for controlling a system to apply a force to a piezoelectric material by touching the piezoelectric material with a test probe; provide a charge signal corresponding to charge generated by the piezoelectric material in response to the force being applied; provide a force signal corresponding to the force applied to the piezoelectric material; and determine a piezoelectric coefficient of the piezoelectric material using the charge signal and the force signal.

In some implementations, the software further includes instructions to determine a voltage value of the charge signal corresponding to one or both of a positive peak or a negative peak of the charge signal; determine a voltage value of the force signal corresponding to one or both of a positive peak or a negative peak of the force signal; and determine the piezoelectric coefficient based on the voltage value of the charge signal and the voltage value of the force signal.

### BRIEF DESCRIPTION OF THE DRAWINGS

Details of one or more implementations of the subject matter described in this specification are set forth in the accompanying drawings and the description below. Other features, aspects and advantages will become apparent from the description, the drawings and the claims. Note that the relative dimensions of the following figures may not be drawn to scale. Like reference numbers and designations in the various drawings indicate like elements.

FIGS. 1A-1C show an example of a schematic diagram of an ultrasonic sensor system.

FIG. 2 shows an example of an exploded view of an ultrasonic sensor system.

FIG. 3A shows an example of a 4×4 pixel array of sensor pixels for an ultrasonic sensor.

FIG. 3B shows an example of a high-level block diagram of an ultrasonic sensor system.

FIG. 4 shows an example of a test probe for characterizing piezoelectric material.

FIG. 5 shows an example of signals provided by the test probes of FIGS. 4, 10 and 11.

FIG. 6 shows another example of a test probe for characterizing piezoelectric material.

FIG. 7 shows another example of a test probe for characterizing piezoelectric material.

FIG. 8 shows an example of a test environment for characterizing piezoelectric material.

FIG. 9 shows an example of a flowchart for characterizing piezoelectric material.

FIG. 10 shows an example of a test probe with a protective coating on the conductive tip for characterizing piezoelectric material.

FIG. 11 shows an example of a test probe with a piezoelectric cap on the conductive tip for characterizing piezoelectric material.

FIG. 12 shows an example of a test probe characterizing piezoelectric material covered by a protective layer.

### DETAILED DESCRIPTION

The following description is directed to certain implementations for the purposes of describing the innovative aspects of this disclosure. However, a person having ordinary skill in the art will readily recognize that the teachings herein may be applied in a multitude of different ways. The described implementations may be implemented in any device, apparatus, or system for ultrasonic sensing. In addition, it is contemplated that the described implementations may be included in or associated with a variety of electronic devices such as, but not limited to: mobile telephones, multimedia Internet enabled cellular telephones, mobile television receivers, wireless devices, smartphones, smart cards, wearable devices such as bracelets, armbands, wristbands, rings, headband, patches, etc., Bluetooth® devices, personal data assistants (PDAs), wireless electronic mail receivers, hand-held or portable computers, netbooks, notebooks, smartbooks, tablet computers, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), mobile health devices, computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also may be used in applications such as, but not limited to, electronic switching devices, radio frequency filters, sensors, accelerometers, gyroscopes, motion-sensing devices, magnetometers, inertial components for consumer electronics, parts of consumer electronics products, steering wheels or other automobile parts, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Some ultrasonic sensor systems use piezoelectric material for the transmission and receiving of ultrasonic waves. Piezoelectric material can be stretched or contracted (e.g., deformed such that it is strained in response to an applied mechanical force or pressure to stress the piezoelectric material), resulting in a surface charge, and therefore, voltage across the piezoelectric material and/or current may be generated. Conversely, applying a voltage across piezoelectric material can result in it being stretched or contracted. As a result, piezoelectric material can be strained to generate an ultrasonic wave by applying a signal to it. Conversely, piezoelectric material can be strained by an ultrasonic wave (e.g., a portion of a generated or transmitted ultrasonic wave that is reflected back from an object such as a finger, as discussed herein) to generate charge that can be sampled to provide a signal representative of the object it is reflected back from.

Piezoelectric material can be characterized in part in terms of its piezoelectric coefficient d₃₃ indicating piezoelectricity (e.g., by way of a non-limiting example, a piezoelectric coefficient d₃₃ may indicate piezoelectricity), which is based on a ratio of charge generated by the piezoelectric material under stress and the force upon the piezoelectric material that generates the stress. The d₃₃ piezoelectric coefficient, sometimes referred to as the d₃₃ piezoelectric strain constant, is generally measured in the thickness direction of a relatively thin sheet of piezoelectric material. Conventional techniques to measure the piezoelectric coefficient d₃₃ may use the Berlincourt method, which uses two test probes positioned on opposite surfaces of the piezoelectric material to make measurements that can be used to determine the piezoelectric coefficient d₃₃. This generally requires that the piezoelectric material be separated from an assembled or semi-assembled product for measurement. That is, with the Berlincourt method, the piezoelectric material must be free-standing with opposing sides exposed to characterize the piezoelectric coefficient d₃₃. Moreover, the Berlincourt method is a generally destructive test, and therefore, the piezoelectric material and the product that it is removed from are generally discarded.

Some implementations of the subject matter described in this disclosure may include a test probe for non-destructive and single-sided piezoelectric material characterization. For example, a test probe may include a conductive tip that strikes or makes contact with a surface of piezoelectric material. This creates force acting upon the piezoelectric material and generates stress in the piezoelectric material. As a result, charge is generated on a surface of the piezoelectric material. The conductive tip of the test probe may include an electrical connection to provide a charge signal that provides a measurement of the generated surface charge. In some implementations, a force sensor such as an in-line piezoelectric force sensor may be mechanically coupled to the conductive tip such that the force sensor can generate a force signal providing a simultaneous measurement of the applied force on the piezoelectric material. An in-line force sensor and conductive tip may be positioned along a common central axis within the test probe. As a result, the piezoelectric coefficient d₃₃ may be determined using the charge signal and the force signal while only probing a single side of the piezoelectric material. Moreover, since only a single side of the piezoelectric material needs to be accessible, the test probe may be used while the piezoelectric material is on a substrate, for example, during an assembly or manufacturing process. For example, in some implementations, a layer of piezoelectric material may be bonded, coated, dispensed or otherwise disposed on a surface of a glass or silicon substrate with co-fabricated TFT or silicon circuitry for in-line testing of the piezoelectric coefficient d₃₃ during manufacturing.

Particular implementations of the subject matter described in this disclosure may be implemented to realize one or more of the following potential advantages. Characterizing the piezoelectric material on a single side allows the piezoelectric material to be tested while it is assembled or formed, for example, on a substrate to be integrated into a product (e.g., within an assemblage of other layers, parts, etc.). This allows for the actual piezoelectric material being integrated into the product to be characterized and tested for quality before completion of the product manufacturing process, resulting in an increase in yield and reliability and a reduction in production cost. Additionally, the test probe and methods may perform in-situ and non-destructive characterization of piezoelectric material.

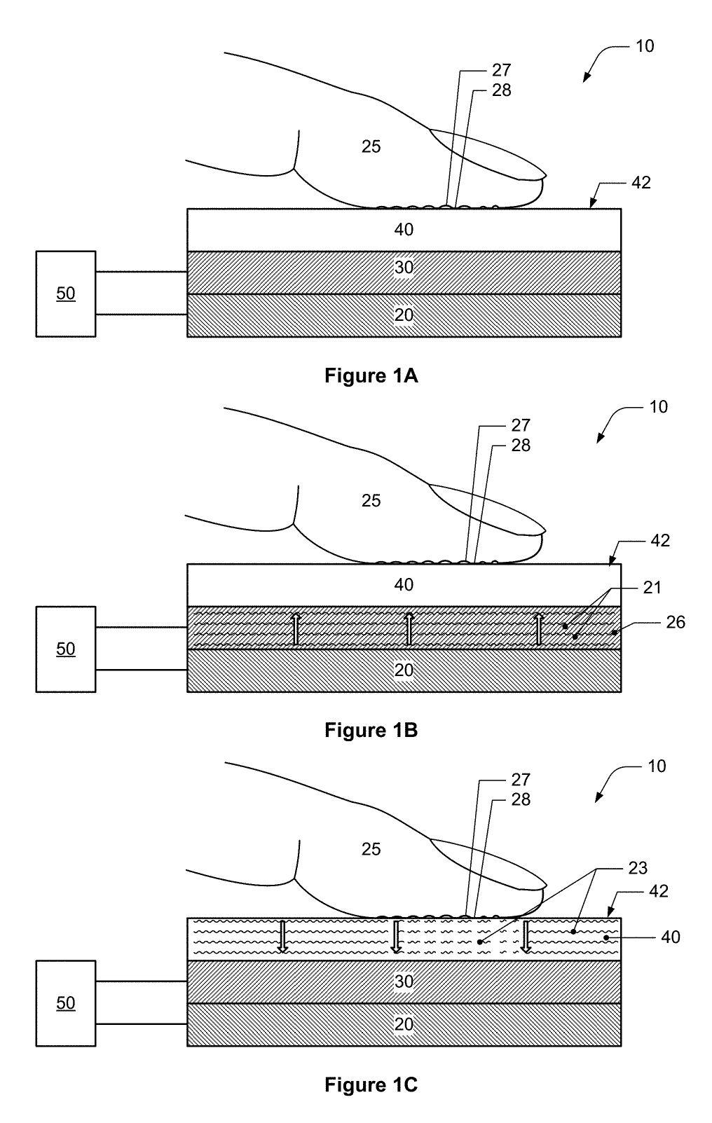

FIGS. 1A-1C show an example of a schematic diagram of an ultrasonic sensor system. As shown in FIG. 1A, ultrasonic sensor system 10 includes an ultrasonic transmitter 20 and an ultrasonic receiver 30 under a platen 40. The ultrasonic transmitter 20 may be a piezoelectric transmitter that can generate ultrasonic waves 21 (see FIG. 1B). The ultrasonic receiver 30 includes a piezoelectric material and an array of pixel circuits disposed on or in a substrate. In operation, the ultrasonic transmitter 20 generates an ultrasonic wave 21 that travels through the ultrasonic receiver 30 to the exposed surface 42 of the platen 40. At the exposed surface 42 of the platen 40, the ultrasonic energy may either be absorbed or scattered by an object 25 that is in contact with the platen 40, such as the skin of a fingerprint ridge 28, or reflected back. In those locations where air contacts the exposed surface 42 of the platen 40, e.g., valleys 27 between fingerprint ridges 28, most of the ultrasonic wave 21 will be reflected back toward the ultrasonic receiver 30 for detection (see FIG. 1C). Control electronics 50 may be electrically coupled to the ultrasonic transmitter 20 and ultrasonic receiver 30 and may supply timing signals that cause the ultrasonic transmitter 20 to generate one or more ultrasonic waves 21. The control electronics 50 may then receive signals from the ultrasonic receiver 30 that are indicative of reflected ultrasonic energy 23. The control electronics 50 may use output signals received from the ultrasonic receiver 30 to construct a digital image of the object 25. In some implementations, the control electronics 50 may also, over time, successively sample the output signals to detect movement of the object 25.

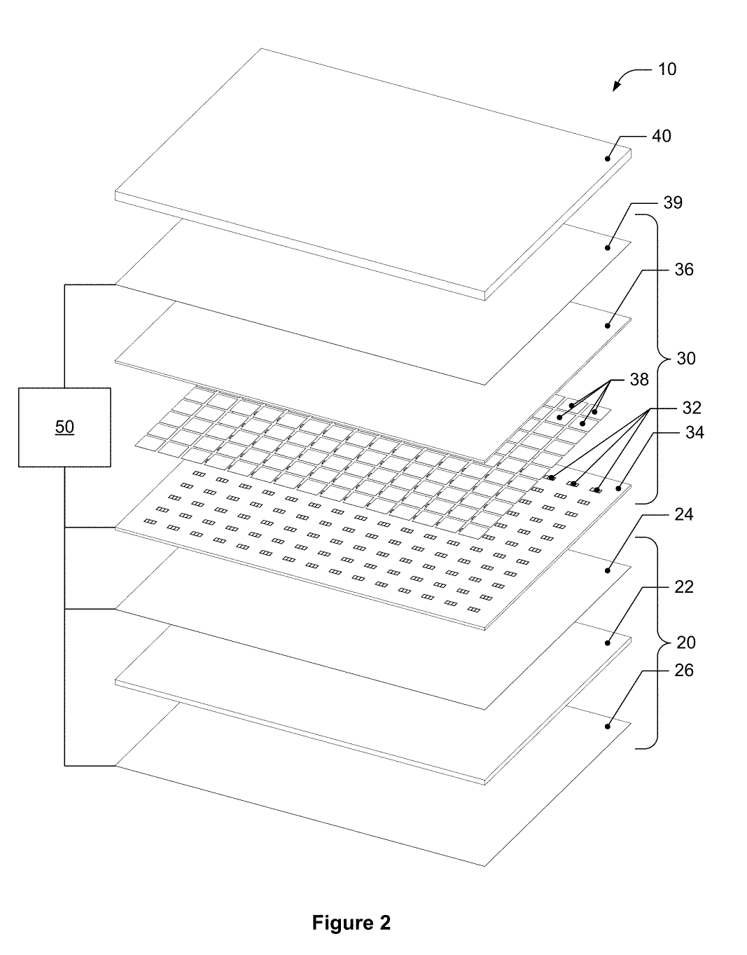

FIG. 2 shows an example of an exploded view of an ultrasonic sensor system 10 including an ultrasonic transmitter 20 and an ultrasonic receiver 30 under a platen 40. The ultrasonic transmitter 20 may be a plane wave generator including a substantially planar piezoelectric transmitter layer 22. Ultrasonic waves may be generated by applying a voltage to the piezoelectric layer to expand or contract the layer, depending upon the signal applied, thereby generating a plane wave. The voltage may be applied to the piezoelectric transmitter layer 22 via a first transmitter electrode 24 and a second transmitter electrode 26. The first and second transmitter electrodes 24 and 26 may be metallized electrodes, for example, metal layers that coat opposing sides of the piezoelectric transmitter layer 22. In this fashion, an ultrasonic wave may be made by modulating the thickness of the layer via a piezoelectric effect. This ultrasonic wave may travel toward a finger (or other object to be detected), passing through the platen 40. A portion of the wave not absorbed by the object to be detected may be reflected so as to pass back through the platen 40 and be received by the ultrasonic receiver 30.

The ultrasonic receiver 30 may include an array of sensor pixel circuits 32 disposed in or on a substrate 34 and a piezoelectric receiver layer 36. In some implementations, each sensor pixel circuit 32 may include one or more TFT or silicon elements, electrical interconnect traces and, in some implementations, one or more additional circuit elements such as diodes, capacitors, and the like. Each sensor pixel circuit 32 may be configured to convert an electric charge generated in the piezoelectric receiver layer 36 proximate to the pixel circuit into an electrical signal. Each sensor pixel circuit 32 may include a pixel input electrode 38 that electrically couples the piezoelectric receiver layer 36 to the sensor pixel circuit 32.

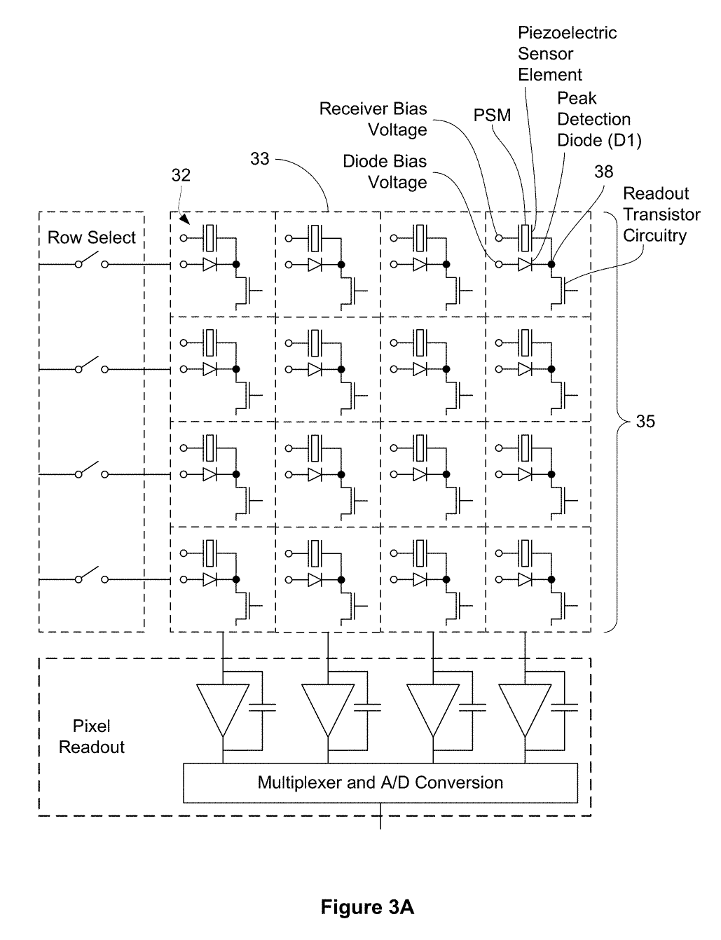

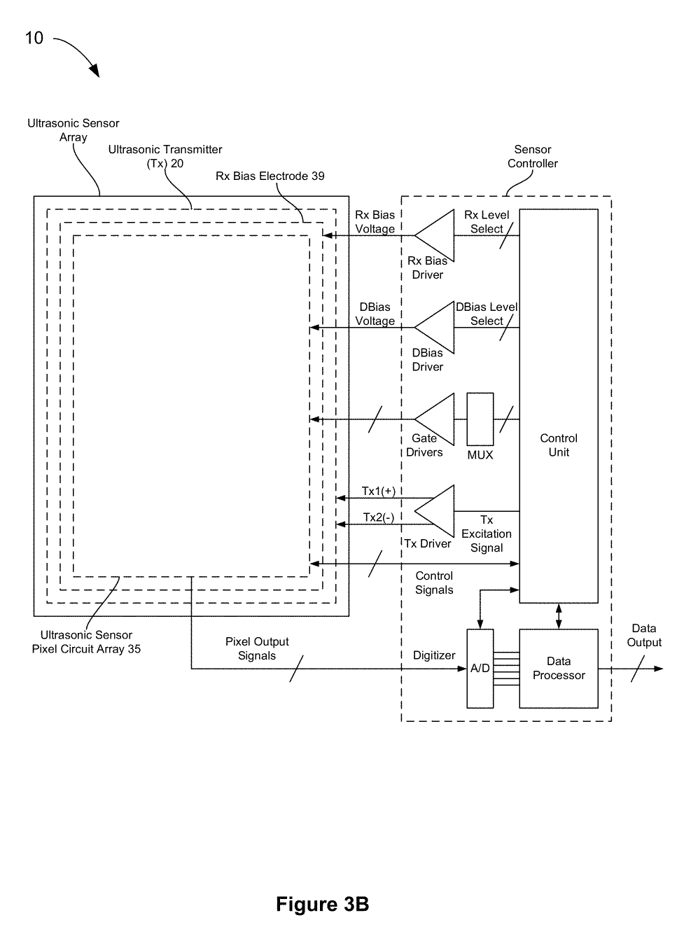

In the illustrated implementation, a receiver bias electrode 39 is disposed on a side of the piezoelectric receiver layer 36 proximal to platen 40. The receiver bias electrode 39 may be a metallized electrode and may be grounded or biased to control which signals may be passed to the array of sensor pixel circuits 32. Ultrasonic energy that is reflected from the exposed (top) surface of the platen 40 may be converted into localized electrical charges by the piezoelectric receiver layer 36. These localized charges may be collected by the pixel input electrodes 38 and passed on to the underlying sensor pixel circuits 32. The charges may be amplified or buffered by the sensor pixel circuits 32 and provided to the control electronics 50, which processes the amplified signals. A simplified schematic of an example sensor pixel circuit 32 is shown in FIG. 3A, however one of ordinary skill in the art will appreciate that many variations of and modifications to the example sensor pixel circuit 32 shown in the simplified schematic may be contemplated.

Control electronics 50 may be electrically connected (directly or indirectly) with the first transmitter electrode 24 and the second transmitter electrode 26, as well as with the receiver bias electrode 39 and the sensor pixel circuits 32 in or on the substrate 34. The control electronics 50 may operate substantially as discussed previously with respect to FIGS. 1A-1C.

The platen 40 may be any appropriate material that can be acoustically coupled to the receiver. Acoustically coupled materials allow the transmission of acoustic waves such as ultrasonic waves from one layer to another. Examples of materials that may be suitable for the platen may include plastic, ceramic, glass, sapphire, gorilla glass, aluminum, stainless steel, a metal, a metal alloy, polycarbonate, a polymeric material, or a metal-filled plastic. In some implementations, the platen 40 can be a cover plate, e.g., a cover glass or a lens glass for a display. Detection and imaging can be performed through relatively thick platens if desired, e.g., 1 mm and above. Acoustic matching layers and/or protective coatings (not shown) may be included with platen 40.

Examples of piezoelectric materials that may be used to form the piezoelectric receiver layer 36 include piezoelectric polymers having appropriate acoustic properties, for example, an acoustic impedance between about 2.5 MRayls and 5 MRayls. Specific examples of piezoelectric materials that may be employed include ferroelectric polymers such as polyvinylidene fluoride (PVDF) and polyvinylidene fluoride-trifluoroethylene (PVDF-TrFE) copolymers. Examples of PVDF copolymers include 60:40 (molar percent) PVDF-TrFE, 70:30 PVDF-TrFE, 80:20 PVDF-TrFE, and 90:10 PVDF-TrFE. Other examples of piezoelectric materials that may be employed include polyvinylidene chloride (PVDC) homopolymers and copolymers, polytetrafluoroethylene (PTFE) homopolymers and copolymers, and diisopropylammonium bromide (DIPAB).

The thickness of each of the piezoelectric transmitter layer 22 and the piezoelectric receiver layer 36 may be selected so as to be suitable for generating and receiving ultrasonic waves. In one example, a PVDF piezoelectric transmitter layer 22 is approximately 28 μm thick and a PVDF-TrFE receiver layer 36 is approximately 12 μm thick. Example frequencies of the ultrasonic waves may be in the range of 5 MHz to 30 MHz, with wavelengths on the order of a millimeter or less.

FIGS. 1A through 1C and 2 show example arrangements of ultrasonic transmitters and receivers in an ultrasonic sensor system, with other arrangements possible. For example, in some implementations, the ultrasonic transmitter 20 may be above the ultrasonic receiver 30 and therefore closer to the object to be detected. In some implementations, the ultrasonic sensor system may include an acoustic delay layer. For example, an acoustic delay layer may be incorporated into the ultrasonic sensor system 10 between the ultrasonic transmitter 20 and the ultrasonic receiver 30. The acoustic delay layer may be employed to adjust the ultrasonic pulse timing, and at the same time electrically insulate the ultrasonic receiver 30 from the ultrasonic transmitter 20. The acoustic delay layer may have a substantially uniform thickness, with the material used for the delay layer and/or the thickness of the delay layer selected to provide a desired delay in the time for reflected ultrasonic energy to reach the ultrasonic receiver 30. In doing so, the range of time during which an energy pulse that carries information about the object by virtue of having been reflected by the object may be made to arrive at the ultrasonic receiver 30 during a time range when it is unlikely that energy reflected from other parts of the ultrasonic sensor system 10 is arriving at the ultrasonic receiver 30. In some implementations, the substrate 34 and/or the platen 40 may serve as an acoustic delay layer. In some implementations, ultrasonic transmitter 20 and ultrasonic receiver 30 may be implemented with a single piezoelectric material layer, for example, that may be disposed on top of the substrate 34.

FIG. 3A shows an example of a sensor pixel array. FIG. 3A representationally depicts aspects of a 4×4 pixel array 35 of sensor pixels 33 for an ultrasonic sensor. Each sensor pixel 33 may be, for example, associated with a local region of piezoelectric sensor material (PSM), a peak detection diode (D1) and a readout transistor; many or all of these elements may be formed on or in a substrate 34 to form the pixel circuit 32. In practice, the local region of piezoelectric sensor material of each sensor pixel 33 may transduce received ultrasonic energy into electrical charges. The peak detection diode D1 may register the maximum amount of charge detected by the local region of piezoelectric sensor material PSM. Each row of the pixel array 35 may then be scanned, e.g., through a row select mechanism, a gate driver, or a shift register, and the readout transistor for each column may be triggered to allow the magnitude of the peak charge for each sensor pixel 33 to be read by additional circuitry, e.g., a multiplexer and an A/D converter. The pixel circuit 32 may include one or more silicon or thin-film transistors to allow gating, addressing, and resetting of the sensor pixel 33.

Each pixel circuit 32 may provide information about a small portion of the object detected by the ultrasonic sensor system 10. While, for convenience of illustration, the example shown in FIG. 3A is of a relatively coarse resolution, ultrasonic sensors having a resolution on the order of 500 pixels per inch or higher may be configured with an appropriately scaled structure. The detection area of the ultrasonic sensor system 10 may be selected depending on the intended object of detection. For example, the detection area may range from about 5 mm×5 mm for a single finger to about 3 inches×3 inches for four fingers. Smaller and larger areas, including square, rectangular and non-rectangular geometries, may be used as appropriate for the target object.

FIG. 3B shows an example of a high-level block diagram of an ultrasonic sensor system 10. Many of the elements shown may form part of control electronics 50. A sensor controller may include a control unit that is configured to control various aspects of the sensor system, e.g., ultrasonic transmitter timing and excitation waveforms, bias voltages for the ultrasonic receiver and pixel circuitry, pixel addressing, signal filtering and conversion, readout frame rates, and so forth. The sensor controller may include a data processor that receives data from the ultrasonic sensor circuit pixel array. The data processor may translate the digitized data into image data of a fingerprint or format the data for further processing. In some implementations, some of the elements shown in FIG. 3B may be removed or relocated. For example, elements such as the bias drivers, gate drivers and Tx driver and associated demultiplexers may be positioned in the ultrasonic sensor array. Likewise, the ultrasonic sensor array may be integrated into the sensor controller. Accordingly, the ultrasonic sensor system may be implemented in a variety of ways.

For example, the control unit may send a transmitter (Tx) excitation signal to a Tx driver at regular intervals to cause the Tx driver to excite the ultrasonic transmitter and produce planar ultrasonic waves. The control unit may send level select input signals through a receiver bias (Rx Bias) driver or a diode bias (DBias) driver to bias the receiver bias electrode and/or the pixel detection diodes D1 to allow gating of acoustic signal detection by the pixel circuitry. A demultiplexer may be used to turn on and off gate drivers that cause a particular row or column of sensor pixel circuits to provide output signals. Output signals from the pixels may be sent through a charge amplifier, a filter such as an RC filter or an anti-aliasing filter, and a digitizer to the data processor. Note that portions of the system may be included on the silicon or TFT substrate and other portions may be included in an associated integrated circuit. In some implementations, the ultrasonic sensor array may be included with the sensor controller and related processor(s) in a single integrated circuit.

As previously discussed, a transmitter excitation voltage may be applied across piezoelectric transmitter layer 22 to expand or contract the layer, resulting in the generation of a plane wave. Reflections of the plane wave may result in force applied to piezoelectric receiver layer 36 and the generation of electric charge that may be used to generate an electrical signal due to the stress from the force being applied. The capability of the piezoelectric material (e.g., piezoelectric receiver layer 36 or piezoelectric transmitter layer 22) to generate electric charge in response to mechanical stress (or the converse) may be characterized in terms of a piezoelectric coefficient, such as piezoelectric coefficient d₃₃. Piezoelectric coefficient d₃₃ represents a ratio of charge generated by the piezoelectric material under stress and the force upon the piezoelectric material that generates that stress. Accordingly, determining the piezoelectric coefficient d₃₃ for piezoelectric receiver layer 36 or piezoelectric transmitter layer 22 may be useful to characterize or test piezoelectric material during the manufacturing process to ensure that ultrasonic sensor systems 10 as shown in FIGS. 1A-C will function properly.

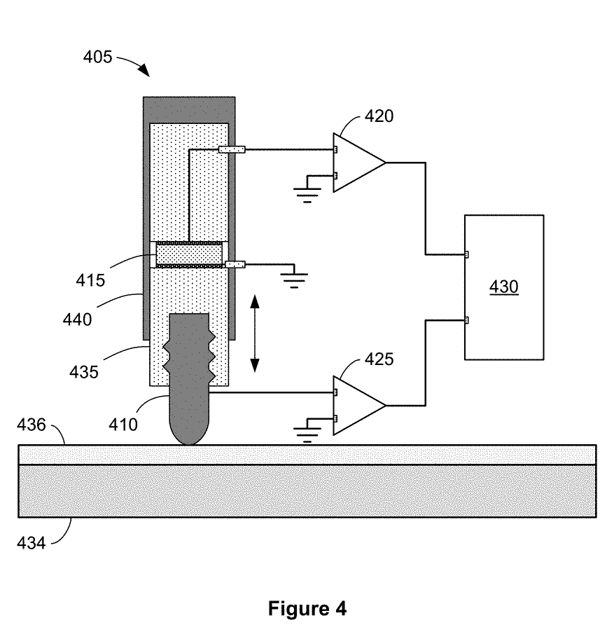

FIG. 4 shows an example of a test probe for characterizing piezoelectric material. Test probe 405 in FIG. 4 may provide for non-destructive and single-sided characterization of piezoelectric coefficient d₃₃ of piezoelectric material. For example, in FIG. 4, test probe 405 may include force sensor 415 that is mechanically coupled to conductive tip 410. In some implementations, test probe 405 may be used to characterize piezoelectric material such as a piezoelectric layer 436. Piezoelectric layer 436 may be a layer of piezoelectric material such as PVDF or PVDF-TrFE copolymer that is disposed on a substrate 434. In some implementations, substrate 434 may be a glass substrate containing thin-film transistor (TFT) circuitry or a silicon substrate containing CMOS circuitry. In some implementations, substrate 434 may be an LCD display substrate or an OLED display substrate. Once diced or otherwise separated, a portion of substrate 434 may serve as substrate 34 and a portion of piezoelectric layer 436 may serve as piezoelectric transmitter layer 22 or piezoelectric receiver layer 36 as described with respect to FIG. 2. In some implementations, piezoelectric layer 436 may serve as a piezoelectric transceiver layer (e.g., a single-layer transmitter and receiver). As test probe 405 strikes, presses or otherwise touches piezoelectric layer 436, a force is applied, resulting in piezoelectric layer 436 experiencing stress. This results in the generation of electric charge on an exterior surface of piezoelectric layer 436. Since conductive tip 410 is conductive (e.g., an electrical conductor such as metal), electric charge may flow into or out from amplifier 425 (e.g., a charge amplifier, a transimpedance amplifier, or such) and subsequently generate a voltage at the output of amplifier 425 representative of the surface charge generated by piezoelectric layer 436 due to the applied stress. Additionally, since force sensor 415 is mechanically coupled to conductive tip 410, force sensor 415 also experiences stress. This may result in the generation of a force signal (e.g., force sensor 415 may be implemented with piezoelectric material) representative of the stress applied by test probe 405 into piezoelectric layer 436. Similarly, amplifier 420 may produce a voltage at its output representative of the stress applied to piezoelectric layer 436. Accordingly, the force signal and the charge signal may be provided to measurement and processing unit 430 to determine piezoelectric coefficient d₃₃ of piezoelectric layer 436.

As shown in FIG. 4, piezoelectric layer 436 is deposited upon a surface of substrate 434. In other implementations, piezoelectric transmitter layer 22 (or other piezoelectric material layer) may be deposited upon a substrate. The piezoelectric material may be deposited during the manufacturing process of ultrasonic sensor system 10. In FIG. 4, since piezoelectric layer 436 is deposited onto a surface of substrate 434, only a single side (e.g., surface) of the piezoelectric material is exposed. Accordingly, determining the piezoelectric coefficient d₃₃ of piezoelectric layer 436 may include applying force and measuring charge generated due to that force using the test probe on the exposed side.

In FIG. 4, test probe 405 includes conductive tip 410 that may be placed upon piezoelectric layer 436 with an applied force such that piezoelectric layer 436 experiences stress, and therefore, charge is generated on the outer surface. Since conductive tip 410 is made of conductive material, this charge may be “picked up” by conductive tip 410 to provide a signal representative of the surface charge (i.e., generate a charge signal). In some implementations, the test probe tip of test probe 405 may include a portion that is non-conductive (e.g., a portion affixed to the conductive tip of test probe 405) and a portion that is conductive. In some implementations, the test probe tip may include conductive tip 410 and force sensor 415 disposed in the test probe tip, along with suitable insulators and electrical connections.

Conductive tip 410 may be electrically connected to a terminal of amplifier 425. In some implementations, a second terminal of amplifier 425 may be grounded. The generated charge signal from conductive tip 410 of test probe 405 may be provided to a terminal of amplifier 425. Amplifier 425 may condition the charge signal, for example, by converting it into a voltage and amplifying the resulting voltage. Other functionality, such as filtering, may be used to reduce or minimize noise and inadvertent pickup of electrical interference. The conditioned charge signal may then be provided to measurement and processing unit 430.

Measurement and processing unit 430 may be external to test probe 405. Measurement and processing unit 430 may include, for example, a computer-controlled acquisition system, an oscilloscope or other laboratory equipment that may be used to process charge and force signals and determine the piezoelectric coefficient d₃₃ of piezoelectric layer 436, as discussed later herein. In some implementations, one or more of measurement and processing unit 430, amplifier 425 and amplifier 420 (described in more detail below) may be implemented within or external to test probe 405. In some implementations, various piezoelectric coefficients such as piezoelectric stress coefficients or piezoelectric strain coefficients may be determined.

Conductive tip 410 may be mechanically coupled to force sensor 415 within test probe 405. For example, test probe 405 may include insulator component 435 such as a plastic, glass or ceramic insulator affixed between (e.g., directly or indirectly with intervening components) conductive tip 410 and force sensor 415. Insulator component 435 may mechanically couple force sensor 415 to conductive tip 410. Accordingly, as conductive tip 410 is struck against a surface of piezoelectric layer 436, a resulting force is also applied to force sensor 415 within test probe 405 via insulator component 435. In some implementations, insulator component 435 may be a non-conductive material such that the charge picked up by conductive tip 410 is not conducted to force sensor 415 via insulator component 435. Force sensor 415 may be implemented with piezoelectric material, a strain gauge or other type of device that may be used to generate a signal representative of the force applied to it.

As force is applied to piezoelectric layer 436, a signal representative of the force being applied may be generated by force sensor 415 (i.e., generate a force signal). The force signal may be provided by a first terminal of force sensor 415. A second terminal of force sensor 415 may be grounded (e.g., terminated at 0 Volts (V)). The force signal may be provided to a first terminal of amplifier 420, which may have a second terminal grounded. The amplifier 420 may condition the force signal in a manner similar to amplifier 425. In some implementations, the gain of amplifiers 420 and 425 may be the same or similar. However, based on the characteristics of force sensor 415, the gains may be different.

In some implementations, case 440 of test probe 405 may be a metallic case. Case 440 may be grounded, allowing for a reduction in electromagnetic interference and therefore noise on the charge signal and the force signal. Similarly, electrical connections between conductive tip 410 and amplifier 425 and between force sensor 415 and amplifier 420 may include a shield layer that may be grounded to reduce noise and electrical interference.

Accordingly, as test probe 405 applies force to piezoelectric layer 436, the charge signal representing the amount of charge generated by piezoelectric layer 436 due to the stress induced by the applied force and the force signal representing the force applied to piezoelectric layer 436 may be provided to measurement and processing unit 430. These two signals may be used to determine the piezoelectric coefficient d₃₃ of piezoelectric layer 436 in FIG. 4.

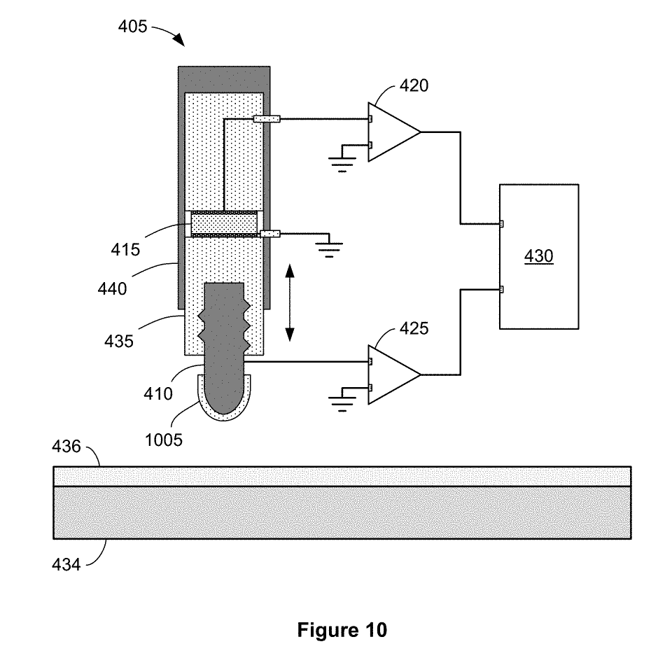

Test probe 405 may include a protective coating on conductive tip 410 such that piezoelectric layer 436 might not be scratched during the testing and/or to protect conductive tip 410 from damage. FIG. 10 shows an example of a test probe with a protective coating on the conductive tip 410 for characterizing piezoelectric material. As shown in FIG. 10, protective coating 1005 may be disposed upon or cover a portion or more of conductive tip 410. Protective coating 1005 may make direct physical contact with piezoelectric layer 436 rather than conductive tip 410, however force is still communicated to the piezoelectric material as previously discussed. In some implementations, protective coating 1005 may include a soft dielectric material (e.g., polytetrafluoroethylene or Teflon) or a hard dielectric material (e.g., diamond or a diamond-like coating). In some implementations, conductive tip 410 may be made of aluminum and may be anodized to form a protective coating 1005 of aluminum oxide from the anodizing process.

When conductive tip 410 with insulating protective coating 1005 comes in contact with a piezoelectric material layer, a capacitive voltage divider occurs between protective coating 1005 of conductive tip 410 and piezoelectric layer 436, and the conductive tip 410 receives a pre-determined fraction of the charge generated by the piezoelectric layer 436. The charge generated by piezoelectric layer 436 as it experiences stress is capacitively coupled to the conductive tip 410, and the generation of the charge signal based on capacitive coupling of the generated charge may be provided to measurement and processing unit 430. That is, charge generated by piezoelectric layer 436 is capacitively coupled to conductive tip 410. In some implementations, protective coating 1005 may be relatively thin, for example, thinner than the thickness of piezoelectric layer 436 to increase the coupling capacitance and to promote capacitive coupling.

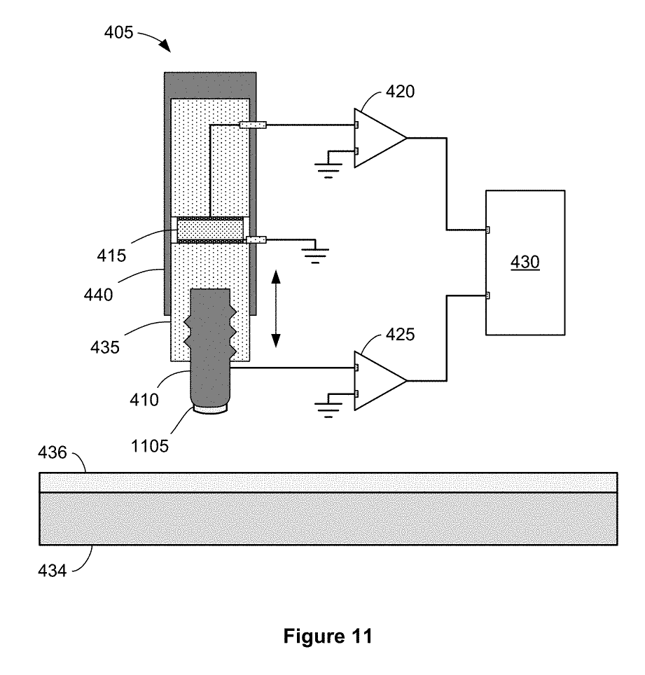

In some implementations, test probe 405 may include a piezoelectric cap 1105 positioned on an outer surface of conductive tip 410 for reducing potential scratching of piezoelectric layer 436, improving repeatability of measurements, and improving acoustic matching between conductive tip 410 and the piezoelectric material under test. FIG. 11 shows an example of a test probe 405 with a piezoelectric cap 1105 on conductive tip 410 for characterizing piezoelectric material. Similar to the example of protective coating 1005 in FIG. 10, piezoelectric cap 1105 may protect piezoelectric layer 436 and/or conductive tip 410. Piezoelectric cap 1105 may serve as a protective coating 1005 disposed on the conductive tip 410. Moreover, piezoelectric cap 1105 may be useful for characterizing piezoelectric materials with a low piezoelectric coefficient d₃₃. For example, since piezoelectric cap 1105 includes a piezoelectric material, surface charge will be generated as test probe 405 applies force to piezoelectric layer 436. Based on the poling of piezoelectric layer 436 and piezoelectric cap 1105, the generated surface charges on the piezoelectric cap 1105 and piezoelectric layer 436 might subtract (e.g., if they are of different polarities) or add (e.g., if they are of same polarities) and therefore be reflected in the charge signal. If piezoelectric layer 436 generates relatively little charge with applied stress, then the charge generated by piezoelectric cap 1105 may provide an offset that can be reflected in the charge signal such that it is a higher magnitude, and therefore, improve the signal-to-noise ratio. This may allow for better repeatability when testing piezoelectric materials with lower d₃₃ values. Additionally, if piezoelectric cap 1105 is made of the same or similar piezoelectric material as piezoelectric layer 436 (e.g., both made of PVDF polymer or PVDF-TrFE copolymer), then acoustic matching may be improved.

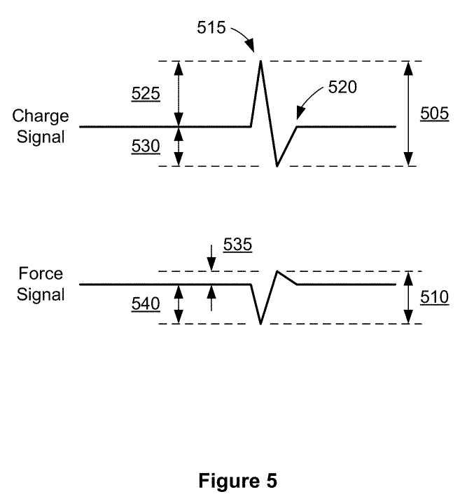

FIG. 5 shows an example of charge signals and force signals generated and provided by the test probes of FIGS. 4, 10 and 11. In FIG. 5, the peak-to-peak voltage values of the charge signal and the force signal may be used to determine the piezoelectric coefficient d₃₃. For example, at time 515, the charge signal begins to “spike up,” or rise, signifying that time 515 is when conductive tip 410 of test probe 405 strikes, presses or otherwise touches piezoelectric layer 436 in FIG. 4. The charge signal may peak as piezoelectric layer 436 compresses. When conductive tip 410 is raised, piezoelectric layer 436 may relax back towards the initial, undeformed state, and therefore, the charge reverses polarity and reaches a negative peak. At time 520, piezoelectric layer 436 no longer experiences applied stress from the compression or relaxation due to contact from conductive tip 410. This results in the charge signal returning to a level representing no charge being produced by piezoelectric layer 436. In a similar manner, the force signal may be generated by reference sensor 415, as previously discussed. Peak-to-peak charge signal 505 and peak-to-peak force signal 510 represent the charge generated by piezoelectric layer 436 and the force applied to piezoelectric layer 436, respectively. That is, the differences between the highest and lowest levels of the voltage of the charge signal and the force signal represent the charge and force, respectively. As a result, the piezoelectric coefficient d₃₃ may be calculated by dividing the charge by the force. In some implementations, a calibration factor such as an offset and/or a gain factor may be applied (e.g., multiplying the gain factor by the result of the division of the charge by the force for gain correction, or subtracting an offset factor from one or both of the charge and force signals for offset correction before multiplying). The calibration factors may compensate the charge and force signals based on the calibration of test probe 405, for example, due to variations in temperature, nonlinearities of the charge or force sensors, amplifier offsets, gain variations, cross-coupling between charge and force channels, etc.

In some implementations, other characteristics of the charge signal and the force signal may be considered to determine the piezoelectric coefficient d₃₃. For example, in FIG. 5, the maximum amplitude of the positive peak 525 may be representative of the generated surface charge. As another example, the maximum amplitude of the negative peak 530 may be representative of the generated surface charge. As another example, the peak-to-peak charge signal 505 may be representative of the generated surface charge. In a similar manner, the positive and negative peaks of the force signal may be individually representative of the force applied. The peak-to-peak force signal 510 may be representative of the applied force. In some implementations, a peak value of the charge signal such as a peak value of positive peak 525, a peak value of negative peak 530, or a peak value of peak-to-peak charge signal 505 may be used to determine the piezoelectric coefficient d₃₃. Similarly, in some implementations, a peak value of the force signal such as a peak value of the positive peak 535, a peak value of negative peak 540, or a peak value of peak-to-peak force signal 510 may be used to determine the piezoelectric coefficient d₃₃. In some implementations, the area under the positive peaks and/or the negative peaks may be used to determine the piezoelectric coefficient d₃₃ (e.g., by integrating the area underneath the positive and/or negative peaks). In some implementations, multiple characteristics may be considered (e.g., positive and/or negative peak values, peak-to-peak values, and/or areas under the peaks). In some implementations, the piezoelectric coefficient may be determined based on one or more voltage values of the charge signal and one or more voltage values of the force signal.

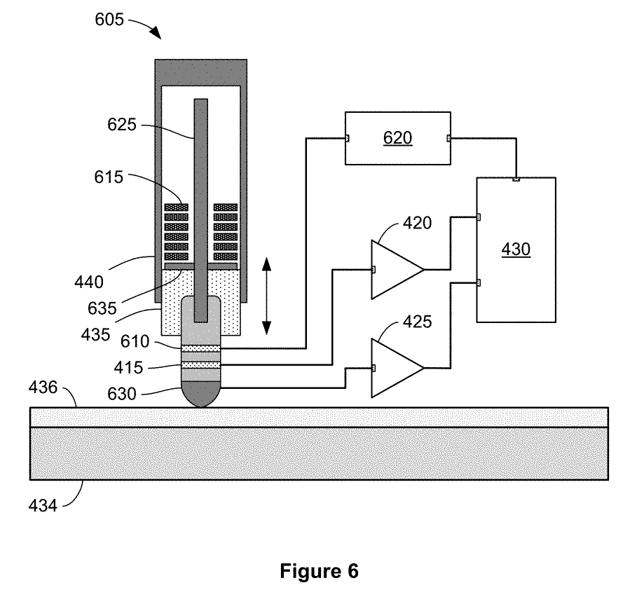

FIG. 6 shows another example of a test probe for characterizing piezoelectric material. In FIG. 6, test probe 605 includes a test probe tip with conductive portion 630, force sensor 415 and driver component 610. Driver component 610 may be used to vibrate conductive portion 630 and apply a dynamic (time-varying) force to piezoelectric layer 436. One or more weights 615 may be arranged within case 440 of test probe 605 such that a controlled static force may be applied to piezoelectric layer 436 when conductive portion 630 of the test probe tip is placed on piezoelectric layer 436.

In more detail, test probe 605 includes a test probe tip including conductive portion 630, force sensor 415, and driver component 610. Though FIG. 6 depicts force sensor 415 integrated within the test probe tip between conductive portion 630 and driver component 610, in other implementations driver component 610 may be integrated within the test probe tip between force sensor 415 and conductive portion 630. Conductive portion 630 is at the end of the test probe tip and is a conductive material, similar to the example of conductive tip 410 of FIG. 4. The material in between conductive portion 630, force sensor 415, and driver component 610 may be a rigid plastic or other non-conductive material (i.e., insulator). While shown as part of the test probe tip of test probe 605 in FIG. 6, driver component 610 may alternatively be positioned along an axis of the test probe, such as along shaft 625. Weights 615 are situated around shaft 625 and within case 440 of test probe 605. The weights may be suspended above the tip by stopper 635, which can retain the weights 615 within the test probe 605 during operation. Weights 615 may be selected to provide a known static force to the piezoelectric material under test when test probe 605 is driven by driver component 610.

Drive circuitry 620 may provide a drive signal to driver component 610 to cause conductive portion 630 to vibrate, and therefore, apply force to piezoelectric layer 436 when touched by the test probe tip. For example, driver component 610 may include a piezoelectric material and associated drive electrodes that repeatedly expands and contracts as it is driven by an oscillating signal (e.g., varying in time around a central value, such as a signal representing a sine wave) by the drive circuitry 620. As a result, conductive portion 630 of the tip of test probe 605 transfers a mechanical vibration to the piezoelectric layer 436. Conductive portion 630 of the tip and force sensor 415 may provide the charge signal and force signal, respectively, to amplifiers 420 and 425 in a manner similar to that described in the example of FIG. 4. In some implementations, measurement and processing unit 430 may provide a control signal to drive circuitry 620 to provide the drive signal to driver component 610 and make measurements regarding the charge signal and force signal to determine the piezoelectric coefficient d₃₃ of piezoelectric layer 436 in a manner similar to that described in the example of FIG. 5. In some implementations, test probe 605 may be positioned against a piezoelectric material under test. Drive circuitry 620 may generate and send an oscillating drive signal to driver component 610 that expands and contracts accordingly, and generates a force that is applied to the piezoelectric material under test. The charge signal from conductive tip 630 and the force signal from force sensor 415 may be used to determine a piezoelectric coefficient d₃₃. In some implementations, a drive signal comprising one or more pulses from drive circuitry 620 may be applied to driver component 610, and a charge signal from conductive tip 630 and force signal from force sensor 415 may be used to determine a piezoelectric coefficient d₃₃. In some implementations, a range of pulses or a range of frequencies may be applied to driver component 610 from drive circuitry 620. For example, specific frequencies in the range from 10 Hz to 100 MHz such as 10 Hz, 100 Hz, 1000 Hz, 0.01 MHz, 0.1 MHz, 1 MHz, 10 MHz, 100 MHz and/or other intervening frequencies may be applied in turn to driver component 610 to allow determination of a piezoelectric coefficient over a range of frequencies. In another example, frequencies may be applied to driver component 610 in a range from a few Hz to a few tens of MHz. In another example, a range of frequencies between 1 MHz and 10 MHz or between 5 MHz and 30 MHz or higher may be applied to driver component 610. In some implementations, the piezoelectric material under test may be characterized over one or more temperatures and/or humidity levels.

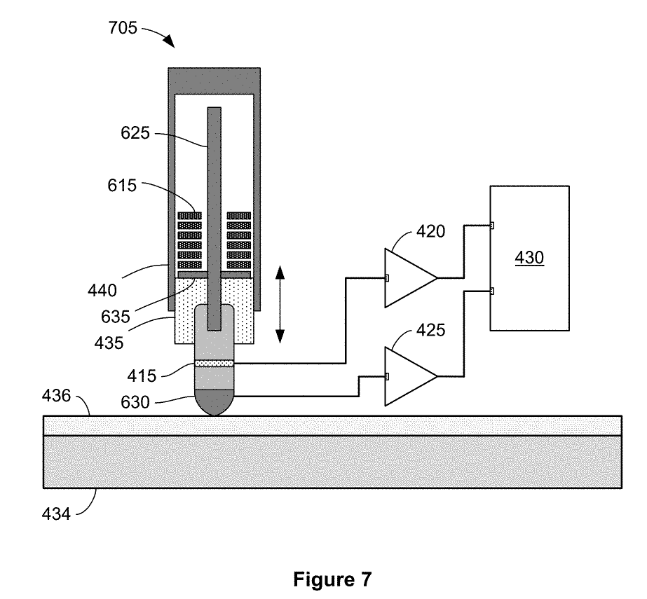

FIG. 7 shows another example of a test probe for characterizing piezoelectric material. In FIG. 7, test probe 705 is similar to test probe 605 in FIG. 6 without driver component 610 disposed within its tip. That is, conductive portion 630 of the tip may touch down on piezoelectric layer 436 and provide a charge signal, force sensor 415 may provide a force signal, and one or more weights 615 may be placed within case 440 of test probe 705. This is similar to the example of test probe 405 in FIG. 4. However, in contrast to test probe 405 in FIG. 4, test probe 705 in FIG. 7 includes force sensor 415 integrated within the test probe tip. A conductive tip represented by conductive portion 630 and the force sensor 415 may be disposed in the test probe tip. Weights 615 provide some control over the force from impacts of conductive portion 630 onto piezoelectric layer 436. The weights 615 may be adjusted based on the amount of force to be applied.

In some implementations, the test probe may include one or more springs. Rather than using weights 615 in test probe 705, one or more springs may be used such that the force applied to piezoelectric layer 436 is proportional to the displacement of the body of test probe 705. That is, the more test probe 705 is pushed down onto piezoelectric layer 436, the more the force being applied increases.

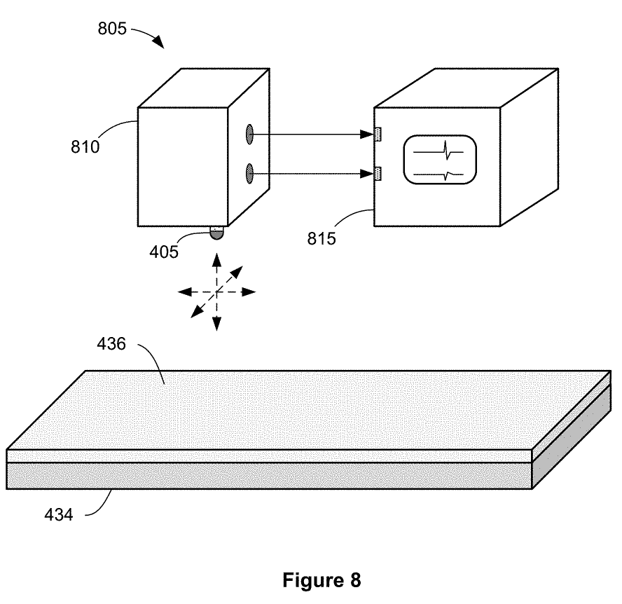

The test probes in the aforementioned examples may be manually operated (e.g., placed onto piezoelectric layer 436 by a human operator) or may be integrated into a more automated production system. FIG. 8 shows an example of a test environment for characterizing piezoelectric material.

In FIG. 8, test probe 405 (or any of the other test probes disclosed in the examples herein) may be placed on probe head 810 of test environment 805 of a production system. Probe head 810 may include multiple test probes 405, for example, to characterize the piezoelectric material at multiple points simultaneously. Additionally, in some manufacturing environments, probe head 810 may include additional probes to determine other characteristics such as thickness probe for determining a layer thickness or a camera for detecting particulates and voids or other defects in the piezoelectric material under test. Placing test probe 405 on probe head 810 allows for the automated characterization of piezoelectric layer 436. Probe head 810 may have one or more positioners (not shown) to position probe head 810 and test probe 405 in one or more predefined positions on piezoelectric layer 436, such as an x-positioner, a y-positioner, and/or a z-positioner. The z-positioner may include height and/or velocity control for controlling an impact or force of test probe 405 on a surface of the piezoelectric material under test. As a result, piezoelectric material may be characterized while it is on, for example, a substrate during the assembly or manufacturing process. In some implementations, test environment 805 may include a chamber (not shown) for temperature and humidity control and/or for dust and particulate control.

The charge signal and force signals generated by test probe 405 may be provided to measurement system 815, which may include measurement and processing unit 430, amplifier 420 and amplifier 425. In some implementations, measurement and processing unit 430 may include a computer, as previously discussed. For example, measurement and processing unit 430 may include one or more signal acquisition cards for converting analog signals to digital signals, processor circuits, display screen, memory, and other hardware components to receive and process the charge signal and the force signal, and to determine the piezoelectric coefficient d₃₃. Measurement and processing unit 430 may also execute stored instructions in memory to determine the piezoelectric coefficient d₃₃ of piezoelectric material as disclosed herein. In some implementations, measurement system 815 may generate data representing a map that indicates the values of piezoelectric coefficient d₃₃ at different positions on a surface of the piezoelectric material. In some implementations, the map may be displayed on a display screen of measurement system 815.

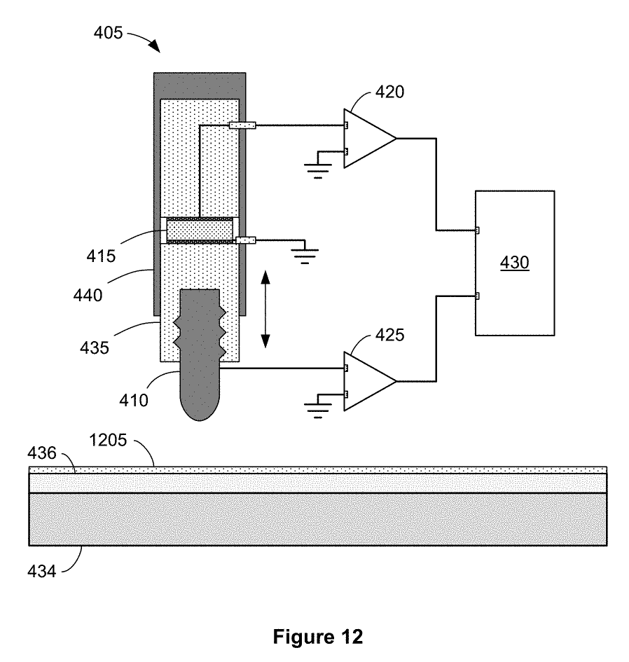

In some implementations, piezoelectric layer 436 may include a thin protective layer or coating disposed on an outer surface of the piezoelectric layer 436. FIG. 12 shows an example of a test probe characterizing piezoelectric material covered by a protective layer 1205. In FIG. 12, protective layer 1205 may be an acrylic coating, a passivation layer, a dielectric layer or other layer disposed upon piezoelectric layer 436. Even though test probe 405 may not directly strike or otherwise touch piezoelectric layer 436, force may indirectly be applied as test probe 405 touches protective layer 1205. Charge generated by piezoelectric layer 436 may generate the charge signal as previously discussed via, for example, capacitive coupling through the protective layer 1205. An assemblage including piezoelectric layer 436 and other layers (e.g., a substrate 434, a protective layer 1205, etc.) may be characterized based on the techniques disclosed herein. However, as discussed above, in some implementations the assemblage might not include a protective layer 1205 disposed on piezoelectric layer 436. In some implementations, a patterned metallized electrode layer (not shown) disposed on an outer surface of piezoelectric layer 436 may be included in the assemblage. The piezoelectric coefficient d₃₃ may be measured and determined by striking, pressing or otherwise touching a patterned feature in the metallized electrode layer. For example, a receiver bias electrode including a patterned square or rectangular feature of silver-urethane ink or other metallization such as chrome-nickel-gold may be disposed in one or more places on the piezoelectric layer 436. The piezoelectric coefficient d₃₃ may be determined by touching the metallized electrode with the test probe as described above. In some assemblages, the metallized electrode layer may be covered with a protective layer 1205 such as an acrylic coating. In some implementations, the piezoelectric coefficient d₃₃ may be determined by touching the receiver bias electrode 39 of a fingerprint sensor during assembly and test.

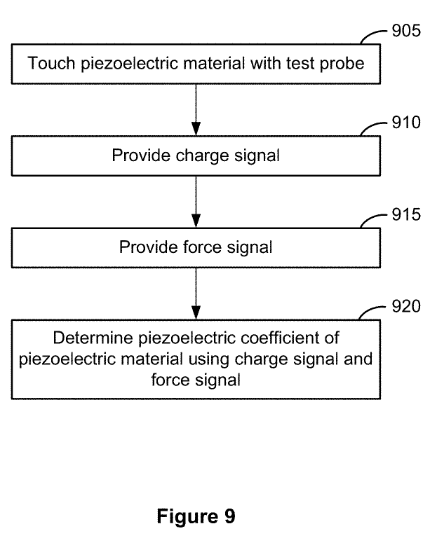

FIG. 9 shows an example of a flowchart for characterizing piezoelectric material. In FIG. 9, at block 905, piezoelectric material may be touched with a test probe. For example, test probe 405 in FIG. 4 may be lowered onto a surface of piezoelectric layer 436 and a force applied thereto, resulting in surface charge generation. In some implementations, a drive signal may be received at a drive component in the test probe and the force may be applied to the piezoelectric material in response to the drive signal. At block 910, a charge signal may be provided by a conductive tip of the test probe. For example, conductive tip 410 of test probe 405 in FIG. 4 may provide a charge signal to amplifier 425. At block 915, a force signal may be provided by the test probe. For example, force sensor 415 of test probe 405 may generate a force signal in response to conductive tip 410 as test probe 405 applies force to piezoelectric layer 436. At block 920, a piezoelectric coefficient of piezoelectric material under test may be determined using the charge signal and the force signal. For example, in FIG. 5, peak-to-peak charge signal 505 and peak-to-peak force signal 510 may be used to calculate piezoelectric coefficient d₃₃ by dividing a value corresponding to the peak-to-peak charge by a value corresponding to the peak-to-peak force. In some implementations, a voltage value of the charge signal corresponding to one or both of a positive peak or a negative peak of the charge signal may be determined and a voltage value of the force signal corresponding to one or both of a positive peak or a negative peak of the force signal may be determined, and the piezoelectric coefficient determined from the voltage value of the charge signal and the voltage value of the force signal. In some implementations, various piezoelectric coefficients such as piezoelectric stress coefficients or piezoelectric strain coefficients may be determined. In some implementations, other material characterization parameters such as thickness, dielectric constant or electromechanical coupling coefficients may be determined.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification may be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium, such as a non-transitory medium. The processes of a method or algorithm disclosed herein may be implemented in a processor-executable software module that may reside on a computer-readable medium. Computer-readable media include both computer storage media and communication media including any medium that may be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those having ordinary skill in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein, if at all, to mean “serving as an example, instance, or illustration.” Any implementation described herein as “exemplary” is not necessarily to be construed as preferred or advantageous over other implementations.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

It will be understood that unless features in any of the particular described implementations are expressly identified as incompatible with one another or the surrounding context implies that they are mutually exclusive and not readily combinable in a complementary and/or supportive sense, the totality of this disclosure contemplates and envisions that specific features of those complementary implementations may be selectively combined to provide one or more comprehensive, but slightly different, technical solutions. It will therefore be further appreciated that the above description has been given by way of example only and that modifications in detail may be made within the scope of this disclosure.

What is claimed is:

1. A test probe for use in characterizing piezoelectric material, the test probe comprising:
a conductive tip configured to apply force to the piezoelectric material when the test probe touches an assemblage including the piezoelectric material, the conductive tip also configured to provide a charge signal representing charge generated in response to the force being applied to the piezoelectric material; and
a force sensor configured to provide a force signal representing the force being applied to the piezoelectric material.

2. The test probe of claim 1, wherein the force sensor is mechanically coupled to the conductive tip.

3. The test probe of claim 2 further comprising:
an insulator component mechanically coupling the force sensor to the conductive tip.

4. The test probe of claim 1, wherein the force sensor is configured to provide the force signal as the force is applied to the piezoelectric material.

5. The test probe of claim 1 further comprising:
a driver component configured to receive a drive signal and vibrate the conductive tip in response to the drive signal.

6. The test probe of claim 1, wherein the charge signal and the force signal are generated using a single side of the piezoelectric material.

7. The test probe of claim 1 further comprising:
a test probe tip in which the conductive tip and the force sensor are disposed.

8. The test probe of claim 1 further comprising:
a protective coating disposed upon the conductive tip and configured to touch the assemblage to apply the force to the piezoelectric material.

9. The test probe of claim 8, wherein the protective coating includes a dielectric material.

10. The test probe of claim 8, wherein the protective coating includes a piezoelectric material.

11. The test probe of claim 1 further comprising:
one or more weights or springs within the test probe, the weights or springs configured to apply the force to the piezoelectric material.

12. A system comprising:
a test probe configured to:
generate a charge signal corresponding to charge generated in response to the test probe applying force to a piezoelectric material, and
generate a force signal corresponding to the force applied to the piezoelectric material; and
a measurement system configured to determine a piezoelectric coefficient of the piezoelectric material based on the charge signal and the force signal.

13. The system of claim 12, wherein a peak value of the charge signal and a peak value of the force signal are used to determine the piezoelectric coefficient.

14. The system of claim 12, wherein the piezoelectric coefficient comprises a piezoelectric coefficient d₃₃ of the piezoelectric material.

15. The system of claim 12, wherein the charge signal is provided by a conductive tip of the test probe, and the force signal is provided by a force sensor integrated within the test probe.

16. The system of claim 15, wherein the force sensor is mechanically coupled to the conductive tip.

17. The system of claim 16, wherein the force sensor is configured to generate the force signal as the force is applied to the piezoelectric material.

18. The system of claim 16, wherein an insulator component mechanically couples the force sensor to the conductive tip.

19. The system of claim 12, wherein the test probe is configured to generate the charge signal and the force signal using a single side of the piezoelectric material.

20. The system of claim 12, wherein the piezoelectric material is assembled on a substrate with a single side of the piezoelectric material exposed to the test probe.

21. A method comprising:
applying a force to a piezoelectric material by touching the piezoelectric material with a test probe;
providing a charge signal corresponding to charge generated by the piezoelectric material in response to the force being applied;
providing a force signal corresponding to the force applied to the piezoelectric material; and
determining a piezoelectric coefficient of the piezoelectric material using the charge signal and the force signal.

22. The method of claim 21, wherein determining the piezoelectric coefficient comprises:
determining a voltage value of the charge signal corresponding to one or both of a positive peak or a negative peak of the charge signal;
determining a voltage value of the force signal corresponding to one or both of a positive peak or a negative peak of the force signal; and
determining the piezoelectric coefficient based on the voltage value of the charge signal and the voltage value of the force signal.

23. The method of claim 21, wherein the force signal is provided as the force is applied to the piezoelectric material.

24. The method of claim 21, wherein the piezoelectric coefficient comprises a piezoelectric coefficient d₃₃ of the piezoelectric material.

25. The method of claim 21 further comprising:
receiving a drive signal at a drive component in the test probe; and
applying the force to the piezoelectric material in response to the drive signal.

26. The method of claim 21, wherein a protective layer or a metallized electrode layer is disposed on a surface of the piezoelectric material, and wherein the force is applied to the piezoelectric material through the protective layer or the metallized electrode layer.

27. A non-transitory medium having software stored thereon, the software including instructions for controlling a system to:
apply a force to a piezoelectric material by touching the piezoelectric material with a test probe;
provide a charge signal corresponding to charge generated by the piezoelectric material in response to the force being applied;
provide a force signal corresponding to the force applied to the piezoelectric material; and
determine a piezoelectric coefficient of the piezoelectric material using the charge signal and the force signal.

28. The non-transitory medium of claim 27, the software further including instructions to:
determine a voltage value of the charge signal corresponding to one or both of a positive peak or a negative peak of the charge signal;
determine a voltage value of the force signal corresponding to one or both of a positive peak or a negative peak of the force signal; and
determine the piezoelectric coefficient based on the voltage value of the charge signal and the voltage value of the force signal.

29. The non-transitory medium of claim 27, wherein the piezoelectric coefficient comprises a piezoelectric coefficient d₃₃ of the piezoelectric material.

30. The non-transitory medium of claim 27, the software further including instructions to:
receive a drive signal at a drive component in the test probe; and
apply the force to the piezoelectric material in response to the drive signal.
